(19) United States
(12) Patent Application Publication
(10) Pub. No.: US 2023/0160532 A1
(43) Pub. Date: May 25, 2023

(54) SAFETY VALVE SYSTEM FOR A COMBUSTION GAS VEHICLE, COMBUSTION GAS VEHICLE, COMPUTER PROGRAM PRODUCT, AND STORAGE MEANS

(71) Applicant: Robert Bosch GmbH, Stuttgart, DE (US)

(72) Inventors: Michael Giuseppe Marino, Kirchberg (Murr) (DE); Ralph Leonard Fung, Stuttgart (DE)

(21) Appl. No.: 17/923,095

(22) PCT Filed: Apr. 14, 2021
(86) PCT No.: PCT/EP2021/059619

§ 371 Date: Nov. 3, 2022

(30) Foreign Application Priority Data
May 7, 2020 (DE) 10 2020 205 778.8

(51) Int. Cl. F17C 7/00; F17C 13/12

(52) U.S. Cl. CPC F17C 7/00; F17C 13/123; F17C 2205/0332; F17C 2205/0352; F17C 2250/038; F17C 2250/032; F17C 2250/0478; F17C 2250/0482; F17C 2270/0178

(57) ABSTRACT

The invention relates to a safety valve system (10a; 10b; 10c) for a combustion gas vehicle (11), having: an excess pressure valve unit (13) with a first gas outlet (14) for discharging excess pressure gas (29) out of a combustion gas tank (12) of the combustion gas vehicle (11) in a first outlet direction (RI) and at least one additional gas outlet (15, 16, 17) for discharging excess pressure gas (29) out of the combustion gas tank (12) in at least one additional outlet direction (R2) which differs from the first outlet direction (RI); a state detection unit (18) for detecting a vehicle position and/or a vehicle orientation of the combustion gas vehicle (11) and/or a surroundings state of the combustion gas vehicle (11); and an adjustment unit (19) for adjusting the discharge of excess pressure gas (29) through the first gas outlet (14) and/or through the at least one additional gas outlet (15, 16, 17) on the basis of the detected current vehicle position, the detected current vehicle orientation, and/or the detected surroundings state. The invention additionally relates to a combustion gas vehicle (11), to a computer program product (26), and to a storage means (26) with a computer program product (26) stored thereon.

### BACKGROUND OF THE INVENTION

The present invention relates to a safety valve system for a combustion gas vehicle, to a combustion gas vehicle, to a computer program product for operating a safety valve system in a combustion gas vehicle, and to a storage means with a computer program product stored thereon.

Known combustion gas vehicles, such as fuel cell vehicles or natural gas vehicles, contain a combustion gas tank containing flammable or at least fire-promoting pressurized gas. In case of a critical overpressure, for example as a result of an accident or incorrect fueling of the combustion gas vehicle, the combustion gas vehicle usually has a pressure relief valve, through which overpressure gas can be released in a controlled manner to the surroundings of the combustion gas vehicle in order to prevent an explosion. The overpressure gas is always released through the pressure relief valve in a specific direction according to the installation position of the pressure relief valve. If, in the event of overpressure, people or susceptible objects are located in the direction of the released gas, considerable damage can occur, in particular if the overpressure gas starts to burn and/or promotes an already existing fire.

### SUMMARY OF THE INVENTION

Within the scope of the present invention there is provided a safety valve system for the safe operation of a combustion gas vehicle. There are further provided a combustion gas vehicle having such a safety valve system, a computer program product for operating a safety valve system according to the invention, and a storage means with a computer program product according to the invention stored thereon. Further embodiments of the invention will become apparent from the dependent claims, the description and the figures. Features which are described in connection with the safety valve system thereby naturally also apply in connection with the combustion gas vehicle according to the invention, the computer program product according to the invention, the storage means according to the invention and in each case vice versa, so that, with regard to the disclosure relating to the individual aspects of the invention, mutual reference is and/or can always be made.

According to a first aspect of the present invention there is provided a safety valve system for a combustion gas vehicle. The safety valve system has a pressure relief valve unit with a first gas outlet for discharging overpressure gas from a combustion gas tank of the combustion gas vehicle in a first outlet direction, and at least one further gas outlet for discharging overpressure gas from the combustion gas tank in at least one further outlet direction which is different from the first outlet direction. The safety valve system further has a state/condition detection unit for detecting a vehicle position and/or a vehicle orientation of the combustion gas vehicle and/or conditions in the vicinity of the combustion gas vehicle. The safety valve system additionally has an adjustment unit for adjusting the discharging of overpressure gas through the first gas outlet and/or through the at least one further gas outlet in dependence on the detected current vehicle position, the detected current vehicle orientation and/or the detected current conditions in the vicinity.

By means of the safety valve system according to the invention, the safety of people and objects in the event of a critical overpressure, which is caused, for example, by the external application of force to the combustion gas tank in the event of an accident, and a resulting outflow of overpressure gas from the combustion gas tank, is increased. Depending on the detected vehicle position, the detected vehicle orientation and/or the detected conditions in the vicinity, the overpressure gas, or the combustion gas escaping from the combustion gas tank, can where possible preferably be discharged, for example, in a direction contrary to the direction of gravity, that is to say in an “upward” direction. It is thus possible, for example, to prevent people located next to a lateral combustion gas outlet from being exposed directly to combustion gas and/or a flame resulting therefrom. The likelihood of injury or damage to people or objects located in the vicinity of the combustion gas vehicle, which is lying upside down or on its side, can thus be reduced.

In addition, by purposively discharging the overpressure gas, or the combustion gas, damage which may possibly be caused to the vehicle itself by the overpressure gas can be reduced. A further advantage of the present invention is that the proposed safety valve system can easily be integrated into existing systems. Thus, for example, already existing pressure relief valves and/or units, such as a pressure relief valve at the gas tank, an exhaust pipe of the combustion gas vehicle, purge valves at a fuel cell stack of a fuel cell vehicle and/or windscreen wiper spray nozzles of the combustion gas vehicle, can be used. Investment costs can thus be kept low.

For detecting the vehicle position and/or the vehicle orientation of the combustion gas vehicle, the state/condition detection unit can have at least one position sensor. A vehicle position can be understood as being the relative position of the combustion gas vehicle in its surroundings. Whether the vehicle is on land, in the water, in a pedestrian zone or in the forest, for example, can make a difference here. The vehicle situation can be understood as being the orientation of the combustion gas vehicle relative to the ground, that is to say whether the combustion gas vehicle is lying on its roof or on its side, for example. The conditions in the vicinity can be understood as being conditions relating to objects and/or people in the vicinity of the safety valve system and/or of the combustion gas vehicle. The conditions in the vicinity change, for example, with different objects and/or people at the combustion gas vehicle. That is to say, with regard to the conditions in the vicinity, it can be assessed, for example, whether people and/or objects are located, could be located or are not located in front of at least one gas outlet.

The pressure relief valve unit can have at least one throttle valve for discharging the overpressure gas from the combustion gas tank into the surroundings of the combustion gas vehicle in a controlled manner. With the throttle valve, the overpressure gas can be steered in the desired direction with low technical outlay.

The combustion gas vehicle can be understood as being a vehicle which can be accelerated using flammable or fire-promoting combustion gas. Thus, the combustion gas vehicle can be understood as being, for example, a fuel cell vehicle, a natural gas vehicle, an LPG vehicle, a CNG vehicle or an autogas vehicle.

For detecting the vehicle position and/or the vehicle orientation of the combustion gas vehicle, the state/condition detection unit can have a parking detection unit. If, for example, the combustion gas vehicle comes to a stop, or is no longer moving, and a parked position cannot be detected, it can be assumed, or this can at least be used as an indication, that the combustion gas vehicle is not standing on its wheels but is lying on its roof or its side, for example. The adjustment unit can be implemented as part of a controller for the combustion gas vehicle. The adjustment unit is furthermore preferably in signaling connection with the state/condition detection unit and with the pressure relief valve unit.

According to a further embodiment of the present invention, it is possible that, in a safety valve system, the pressure relief valve unit has, for discharging overpressure gas from the combustion gas tank, at least a first pressure relief valve for discharging the overpressure gas through a first gas outlet and at least one further pressure relief valve for discharging the overpressure gas through at least one further gas outlet. That is to say, the pressure relief valve unit can have a plurality of pressure relief valves at different locations in the vehicle. Thus, the desired discharge of the overpressure gas in as many different directions as possible can particularly effectively be accommodated. By means of the pressure relief valves, the overpressure gas can additionally be discharged particularly quickly, and consequently the overpressure can be reduced correspondingly quickly. Each of the pressure relief valves can be in the form of a throttle valve and/or a multiway valve or can comprise such a valve. For the desired actuation of the pressure relief valves there can be provided at least one actuator which is in signaling connection with the adjustment unit. The at least one actuator can actuate the pressure relief valves using information from the state/condition detection unit. The first pressure relief valve can be configured to discharge the overpressure gas in different directions through different gas outlets.

According to a further embodiment variant of the present invention, it is furthermore possible that, in a safety valve system, the pressure relief valve unit has at least one pressure relief valve for discharging the overpressure gas through the first gas outlet and the at least one further gas outlet. Thus, the pressure relief valve unit can have, for example, only a single pressure relief valve for discharging the overpressure gas in different directions. Such a solution is particularly space-saving and can be implemented simply and inexpensively. Equally, the proposed safety valve system can also have a plurality of such pressure relief valves, each of which is configured for discharging the overpressure gas in different directions.

Furthermore, in a safety valve system according to the present invention, the state/condition detection unit can have at least one acceleration sensor and/or at least one gyro sensor for detecting the vehicle position and/or the vehicle orientation of the combustion gas vehicle. By means of such a sensor system, the vehicle orientation in particular can reliably be detected. By precisely determining the vehicle orientation, a correspondingly high degree of operating safety for the combustion gas tank, or the combustion gas vehicle, can be achieved.

It is furthermore possible that the state/condition detection unit in a safety valve system according to the invention has at least one radar unit, at least one camera and/or at least one lidar unit for detecting the vehicle position and/or the vehicle orientation of the combustion gas vehicle. Both the vehicle orientation and the vehicle position, for example in relation to other vehicles and/or objects, can thus reliably be detected. In particular, objects and/or people in front of a possible gas outlet can be detected and correspondingly taken into account in the choice of gas outlets. Such a system also provides the basis for establishing a high degree of operating safety in the use of the combustion gas tank and/or of the combustion gas vehicle.

A safety valve system according to the present invention can additionally have a visualization unit for visually marking a gas flame of the overpressure gas at the pressure relief valve unit. Thus, when combustion gas in the form of hydrogen is used for a fuel cell of the combustion gas vehicle, a dye, for example, can be added by the visualization unit to the overpressure gas, or to the hydrogen that is escaping, so that any hydrogen flame burns in a wavelength range that is visible to humans. People at the combustion gas vehicle are able to purposively avoid a visible flame. Moreover, a visible flame can be extinguished purposively and correspondingly quickly. It is possible to dispense with the use of, for example, a thermal imaging camera. With the proposed embodiment, the operating safety of the combustion gas tank and/or of the combustion gas vehicle can therefore be increased further in a simple manner.

A safety valve system according to the present invention can additionally have a pipeline, formed at the pressure relief valve unit, for discharging the overpressure gas into the surroundings of the safety valve system at a distance from the combustion gas tank. By means of the proposed pipeline, the gas outlet location can in principle be defined at any desired position easily and inexpensively. The chimney effect in the pipeline can furthermore be used for guiding the overpressure gas. The pressure relief valve unit can have one pipeline or a plurality of pipelines, in each case configured for discharging the overpressure gas into the surroundings of the safety valve system in different directions. The pipeline can be designed with a length of several centimeters, for example longer than 20 cm or longer than 50 cm, for discharging the overpressure gas at a corresponding distance from the combustion gas tank.

According to a further aspect of the present invention there is provided a combustion gas vehicle having a combustion gas tank and a safety valve system as described in detail above. The combustion gas vehicle according to the invention thus has the same advantages as have been described in detail in relation to the safety valve system according to the invention. The gas outlet or at least some of the gas outlets can be formed at the combustion gas tank and/or at a distance from the combustion gas tank. Thus, the gas outlet or at least one of a plurality of gas outlets can be arranged at a distance of more than 20 cm and/or of more than 100 cm from the combustion gas tank. At least one pressure relief valve according to the invention can likewise be arranged at a distance from the combustion gas tank as well as directly at the combustion gas tank, in particular in the case of the use of a hydrogen tank.

There is additionally proposed within the scope of present invention a computer program product which comprises commands which, when the computer program product is executed by a computer, cause the computer to operate a safety valve system as described in detail above. That is to say, the safety valve system can be configured for operation using the computer program product. The computer program product according to the invention thus also has the advantages described above.

The computer program product can be implemented in the form of computer-readable instruction code in any suitable programming language, such as, for example, in JAVA, C++, C# and/or Python. The computer program product can be stored on a computer-readable storage medium such as a data disk, a removable disk drive, a volatile or non-volatile memory, or a built-in memory/processor. The instruction code can program a computer or other programmable devices, such as a vehicle controller, such that the desired functions are carried out. Furthermore, the computer program product can be and/or can have been provided in a network such as, for example, the internet, from which it can be downloaded by a user as required. The computer program product can be and/or can have been implemented both by means of software and by means of one or more special electronic circuits, that is to say in hardware or in any desired hybrid form, that is to say by means of software components and hardware components.

According to a further aspect of the present invention there is additionally provided a storage means with a computer program product, as has been described above, stored thereon. The storage means is preferably configured in the form of a non-volatile storage means.

### BRIEF DESCRIPTION OF THE DRAWINGS

Further measures enhancing the invention will become apparent from the following description relating to different exemplary embodiments of the invention, which are shown schematically in the figures. All the features and/or advantages, including structural details and spatial arrangements, which follow from the claims, the description or the figures can be essential to the invention both on their own and in the various combinations.

In the figures, in each case in schematic form:

FIG. 1 shows a combustion gas vehicle having a safety valve system according to a first embodiment of the present invention,

FIG. 2 shows a pressure relief valve in a first operating position,

FIG. 3 shows a pressure relief valve in a second operating position,

FIG. 4 shows a pressure relief valve in a third operating position,

FIG. 5 is a block diagram showing a safety valve system having a computer program product according to the invention,

FIG. 6 is a block diagram showing a storage means according to the invention,

FIG. 7 shows a combustion gas vehicle having a safety valve system according to a second embodiment of the present invention,

FIG. 8 shows a combustion gas vehicle having a safety valve system according to a third embodiment of the present invention in a side view,

FIG. 9 shows a combustion gas vehicle having a safety valve system according to the third embodiment of the present invention in a plan view,

FIG. 10 shows a combustion gas vehicle in a first accident position, and

FIG. 11 shows a combustion gas vehicle in a second accident position.

### DETAILED DESCRIPTION

Elements having the same function and effect are in each case provided with the same reference signs in the figures.

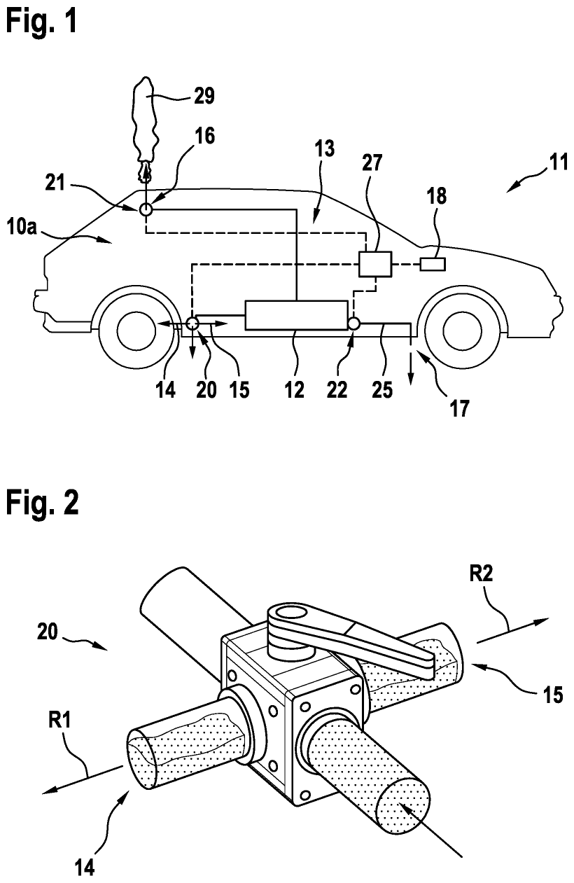

FIG. 1 shows a combustion gas vehicle 11 having a combustion gas tank 12 and a safety valve system 10a according to a first embodiment. The safety valve system 10a has a pressure relief valve unit 13 with a first pressure relief valve 20, a second pressure relief valve 21 and a third pressure relief valve 22. The pressure relief valves 20, 21, 22 are configured and arranged to discharge overpressure gas 29 from the combustion gas tank 12 of the combustion gas vehicle 11 in different outlet directions through different gas outlets 14, 15, 16, 17.

The safety valve system 10a shown further has a state/condition detection unit 18 for detecting conditions in the vicinity of the combustion gas vehicle 11, or around the combustion gas vehicle 11, and also for detecting a vehicle position and a vehicle orientation of the combustion gas vehicle 11. The safety valve system 10a additionally has an adjustment unit 19, which is implemented in a computer 27 of the combustion gas vehicle 11 and shown in FIG. 3, for adjusting a discharge of overpressure gas 29 through the different gas outlets 14, 15, 16, 17 in dependence on the detected current vehicle position and/or the detected current vehicle orientation. The computer 27 can be provided in the form of a vehicle controller or as part of the vehicle controller of the combustion gas vehicle 11. The safety valve system 10a shown in FIG. 1 additionally has a pipeline 25, formed at the pressure relief valve unit 13, or at the fourth pressure relief valve 22, for discharging the overpressure gas 29 into the surroundings of the safety valve system 10a at a distance from the combustion gas tank 12. Thus, the overpressure gas 29 can be discharged in principle at any desired position in and/or at the combustion gas vehicle 11 at a distance from the combustion gas tank 12 which corresponds to the length and/or shape of the pipeline 25. If the combustion gas vehicle 11 shown in FIG. 1 were lying on its roof, for example, any overpressure gas 29 would preferably be discharged, with corresponding operation of the adjustment unit 19, through the fourth pressure relief valve 22 and the first pressure relief valve 20, or the corresponding gas outlets 14, 15, 17.

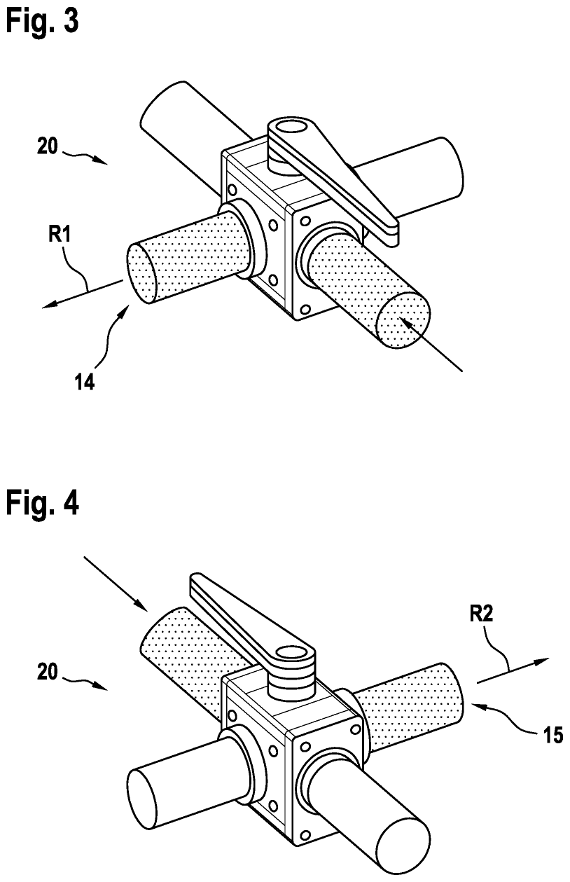

FIG. 2 shows a pressure relief valve 20 in the form of a multiway throttle valve. The pressure relief valve 20 shown is configured to discharge the overpressure gas 29 through a first gas outlet 14 in a first outlet direction R1 and through a further gas outlet 15 in a further outlet direction R2 which is different from the first outlet direction R1. The pressure relief valve 20 shown in FIG. 2 discharges the overpressure gas 29 through each of the two gas outlets 14, 15 in a throttled manner. FIG. 3 shows the pressure relief valve 20 in a further operating position in which the pressure relief valve 20 guides the overpressure gas 29 only in the first outlet direction R1. According to FIG. 4, the pressure relief valve 20 is adjusted such that the overpressure gas 29 is guided only in the outlet direction R2.

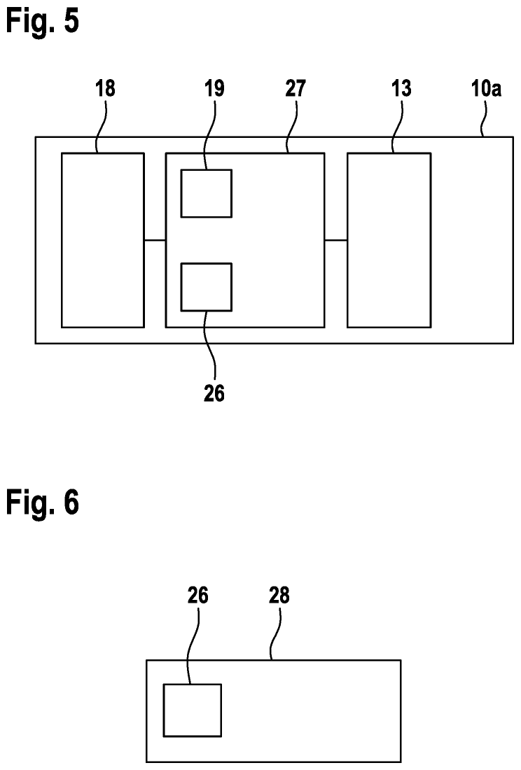

FIG. 5 shows a block diagram of a safety valve system 10a according to the first embodiment. The safety valve system 10a shown has a pressure relief valve unit 13, a state/condition detection unit 18 and a computer 27. There is installed in the computer 27 a computer program product 26 which has commands which, when the computer program product 27 is executed by the computer 27, cause the computer to operate the safety valve system 10a described above. The computer 27 is in signaling connection both with the state/condition detection unit 18 and with the pressure relief valve unit 13. FIG. 6 shows a storage means 28 with a computer program product 26 stored thereon.

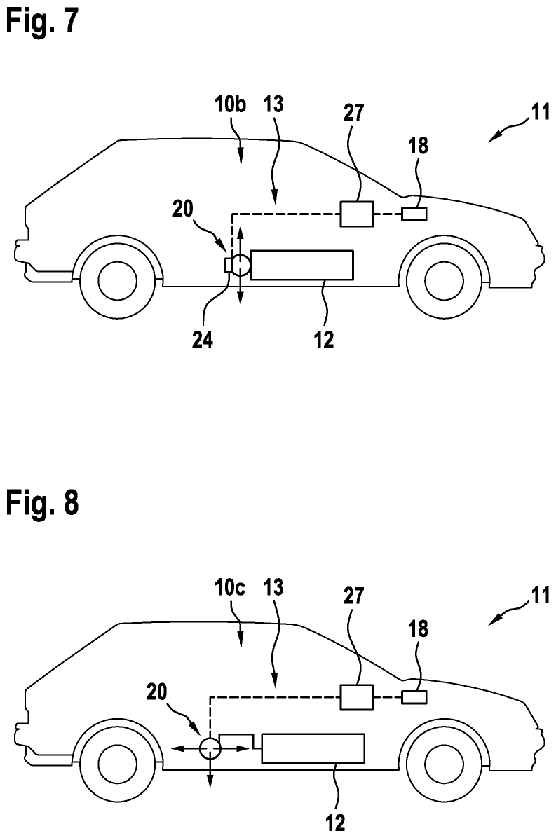

FIG. 7 shows a combustion gas vehicle 10b according to a second embodiment. According to the embodiment shown in FIG. 7, the safety valve system 10b has a visualization unit 24 for visually marking a gas flame of the overpressure gas 29 at the pressure relief valve unit 13. The combustion gas tank 12 in FIG. 7 is a hydrogen tank. Thus, hydrogen that escapes, or a hydrogen flame, can be made visible to the human eye by the addition of suitable particles, for example.

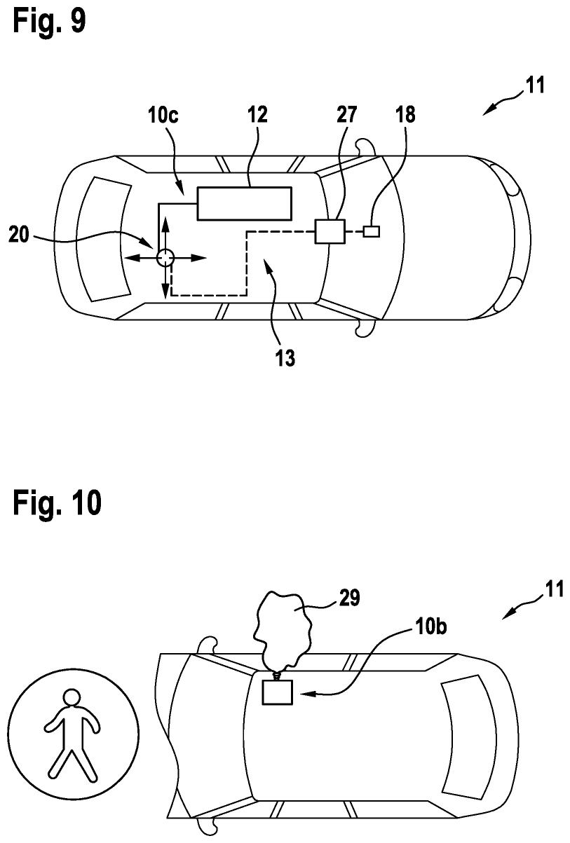

FIG. 8 shows a combustion gas vehicle 10c according to a third embodiment in a side view. The combustion gas vehicle 10c shown has only a single pressure relief valve 20 for discharging the overpressure gas in a plurality of different outlet directions. In FIG. 9, the combustion gas vehicle 10c according to the third embodiment is shown again in a plan view.

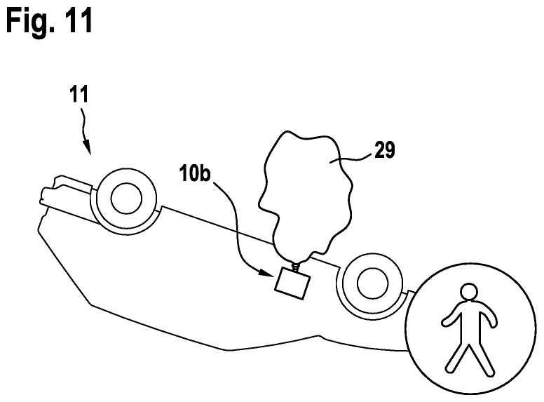

Looking at FIGS. 10 and 11, it can be seen how overpressure gas 29 can be discharged in different outlet directions by a safety valve system 10b in dependence on the detected current vehicle position.

In addition to the embodiments shown, the invention permits further design principles. That is to say, the invention is not to be considered as being limited to the exemplary embodiments explained with reference to the figures.

Thus, the state/condition detection unit 18 can have at least one acceleration sensor and/or at least one gyro sensor for detecting the vehicle position and/or the vehicle orientation of the combustion gas vehicle 11. Moreover, the state/condition detection unit 18 can have at least one radar unit, at least one camera and/or at least one lidar unit for detecting the vehicle position and/or the vehicle orientation of the combustion gas vehicle 11.

1. A safety valve system (10a; 10b; 10c) for a combustion gas vehicle (11), having:
a pressure relief valve unit (13) with a first gas outlet (14) for discharging overpressure gas (29) from a combustion gas tank (12) of the combustion gas vehicle (11) in a first outlet direction (R1) and at least one further gas outlet (15, 16, 17) for discharging overpressure gas (29) from the combustion gas tank (12) in at least one further outlet direction (R2) which is different from the first outlet direction (R1),
a state/condition detection unit (18) configured to detect (i) a vehicle position of the combustion gas vehicle (11), (ii) a vehicle orientation of the combustion gas vehicle (11), (iii) conditions in a vicinity of the combustion gas vehicle (11), or any combination of (i), (ii), and (iii), and
an adjustment unit (19) for adjusting a discharge of overpressure gas (29) through the first gas outlet (14) and/or through the at least one further gas outlet (15, 16, 17) in dependence on the detected current vehicle position, the detected current vehicle orientation and/or the detected current conditions in the vicinity.

2. The safety valve system (10a) as claimed in claim 1,
wherein
the pressure relief valve unit (13) has, for discharging overpressure gas (29) from the combustion gas tank (12), at least a first pressure relief valve (20) for discharging the overpressure gas (29) through a first gas outlet (14) and at least one further pressure relief valve (21, 22) for discharging the overpressure gas (29) through at least one further gas outlet (16, 17).

3. The safety valve system (10a; 10b; 10c) as claimed in claim 1,
wherein
the pressure relief valve unit (13) has at least one pressure relief valve (20) for discharging the overpressure gas (29) through the first gas outlet (14) and the at least one further gas outlet (15).

4. The safety valve system (10a; 10b; 10c) as claimed in claim 1,
wherein
the state/condition detection unit (18) has an acceleration sensor, a gyro sensor, or both an acceleration sensor and a gyro sensor.

5. The safety valve system (10a; 10b; 10c) as claimed in claim 1,
wherein
the state/condition detection unit (18) has a radar unit, a camera and/or a lidar unit.

6. The safety valve system (10b) as claimed in claim 1,
further comprising
a visualization unit (24) for visually marking a gas flame of the overpressure gas (29) at the pressure relief valve unit (13).

7. The safety valve system (10a) as claimed in claim 1,
further comprising
a pipeline (25), formed at the pressure relief valve unit (13), for discharging the overpressure gas (29) into the surroundings of the safety valve system (10a; 10b) at a distance from the combustion gas tank (12).

8. A combustion gas vehicle (11) having a combustion gas tank (12) and a safety valve system (10a; 10b; 10c) as claimed in claim 1.

9. A non-transitory, computer readable medium containing instructions that, when executed by a computer (27), cause the computer to operate a safety valve system (10a; 10b; 10c) having:
a pressure relief valve unit (13) with a first gas outlet (14) for discharging overpressure gas (29) from a combustion gas tank (12) of the combustion gas vehicle (11) in a first outlet direction (R1) and at least one further gas outlet (15, 16, 17) for discharging overpressure gas (29) from the combustion gas tank (12) in at least one further outlet direction (R2) which is different from the first outlet direction (R1).

10. (canceled)
